(19) United States
(12) Patent Application Publication
(10) Pub. No.: US 2006/0020892 A1
(43) Pub. Date: Jan. 26, 2006

(54) Electronic apparatus and video data receiver

(75) Inventors: Makoto Midorikawa, Tokyo (JP); Mitsuhiko Obara, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/185,716

(22) Filed: Jul. 21, 2005

(30) Foreign Application Priority Data
Jul. 21, 2004 (JP) 2004-213298

(51) Int. Cl. H04N 5/44

(52) U.S. Cl. 715/718

(57) ABSTRACT

A TV tuner capture unit not only can output video data compressed and coded by an MPEG2 encoder onto a PCI bus, but also can transmit uncompressed digital video data directly to a high quality video engine (HVE). The uncompressed digital video data is transmitted to the high quality video engine via a video data transmission path, and the PCI bus is not used. The high quality video engine corrects the image quality of the video data and then displays the video data on an LCD.

### CROSS-REFERENCE TO RELATED APPLICATIONS

This application is based upon and claims the benefit of priority from the prior Japanese Patent Application No. 2004-213298, filed on Jul. 21, 2004; the entire content of which is incorporated herein by reference.

### BACKGROUND

1. Field

Embodiments of the invention relate to an electronic apparatus such as a personal computer and a video data receiver used with the electronic apparatus.

2. Description of the Related Art

In recent years, a personal computer including an AV playback function like that of an audio video (AV) machine such as a DVD (Digital Versatile Disk) player or a TV has been developed.

For example, JP-A-2002-108486 discloses a personal computer installing a DVD drive and a TV tuner. In the computer in JP-A-2002-108486, video data obtained from the TV tuner is processed by an image controller and then is displayed on a display section directly connected to the image controller.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is an exemplary perspective view to show the appearance of a computer according to one embodiment of the invention.

FIG. 2 is a block diagram to show the system configuration of the computer in FIG. 1.

FIG. 3 is a block diagram to show the configuration of a receiver installed in the computer in FIG. 1.

FIG. 4 is a flowchart to describe a procedure example of high image quality display processing executed by the computer in FIG. 1.

FIG. 5 is a flowchart to show a procedure example of TV function high-speed start processing executed by the computer in FIG. 1.

### DETAILED DESCRIPTION

Referring now to the accompanying drawings, there is shown a preferred embodiment of the invention.

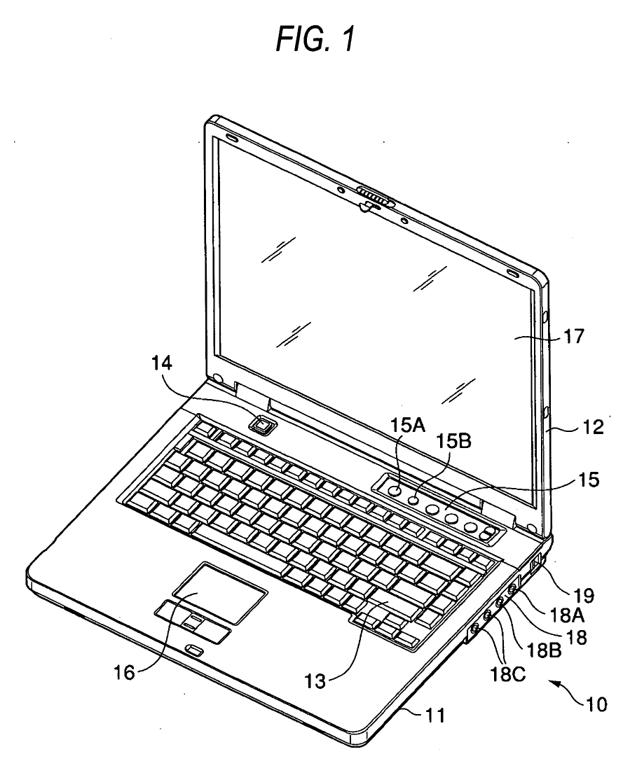

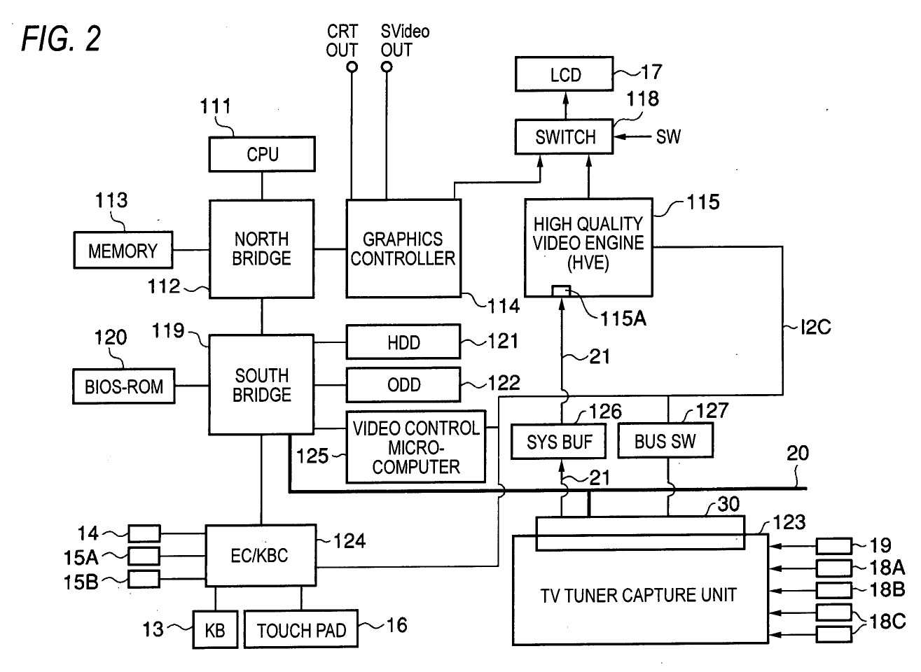

To begin with, the configuration of an electronic apparatus according to one embodiment of the invention will be discussed with reference to FIGS. 1 and 2. The electronic apparatus is implemented as an information processing apparatus such as a notebook personal computer 10, for example.

FIG. 1 is a front view of the notebook personal computer 10 with a display unit thereof open. The computer 10 is made up of a computer main unit 11 and a display unit 12. A display implemented as an LCD (Liquid Crystal Display) 17 is built in the display unit 12, and a display screen of the LCD 17 is positioned almost in the center of the display unit 12.

The display unit 12 is attached to the computer main unit 11 for rotation between an open position and a closed position of the computer. The computer main unit 11 has a thin box-shaped cabinet on which a keyboard 13, a power button 14 for turning on/off power of the computer 10, an input operation panel 15, a touch pad 16, and the like are placed.

The input operation panel 15 is an input unit for inputting an event corresponding to the pressed button and includes a plurality of buttons for starting a plurality of functions. The buttons also include a TV start button 15A and a channel changing button 15B. The TV start button 15A is a button for receiving and playing back TV broadcast program data without starting an operating system. The channel changing button 15B is a button for selecting the channel of the TV broadcast program data to be viewed/recorded. Whenever the user presses the channel changing button 15B, the channel of the TV broadcast program data to be viewed/recorded is changed in order.

An AV (audio video) connector set 18 and a TV antenna connector 19 are provided on one side of the computer main unit 11. ATV antenna cable is connected to the TV antenna connector 19. The AV (audio video) connector set 18 provides connectors for inputting AV data from an external machine and includes a composite video input connector 18A, an S video input connector 18B, and two audio input connectors (audio-L and audio-R) 18C.

Next, the system configuration of the computer 10 will be discussed with reference to FIG. 2.

As shown in FIG. 2, the computer 10 includes a CPU 111, a north bride 112, main memory 113, a graphics controller 114, a high quality video engine (HVE) 115, a switch 118, a south bridge 119, a BIOS-ROM 120, a hard disk drive (HDD) 121, an optical disk drive (ODD) 122, a TV tuner capture unit 123, an embedded controller/keyboard controller IC (EC/KBC) 124, a video control microcomputer 125, a data buffer (SYS BUF) 126, a bus switch (BUS SW) 127, and the like.

The CPU 111 is a processor provided for controlling the operation of the computer 10 and executes the operating system (OS) and various application programs loaded into the main memory 113 from the hard disk drive (HDD) 121. The OS has a window system for displaying a plurality of windows on a display screen.

Video data (for example, TV broadcast program data, video data input from an external machine, etc.,) usually is displayed in a window corresponding to a TV application program. In this case, for example, the window corresponding to the TV application program is placed on a desktop screen and video data is displayed in the window (window mode). The computer 10 can also display the video data on the display screen of the LCD 17 in a full screen mode. In the full screen mode, only the video data is displayed in almost all area on the display screen.

The CPU 111 also executes system BIOS (Basic Input Output System) stored in the BIOS-ROM 120. The system BIOS is a program for controlling hardware.

The north bride 112 is a bridge device for connecting a local bus of the CPU 111 and the south bridge 119. The north bride 112 also includes a memory controller for controlling access to the main memory 113. The north bride 112 also has a function of executing communications with the graphics controller 114 via an AGP (Accelerated Graphics Port) bus, etc.

The graphics controller 114 is a display controller for controlling the LCD 17 used as a display monitor of the computer 10. The graphics controller 114 has video memory (VRAM) and generates a video signal that can be displayed on the LCD 17 from display data written into the video memory (VRAM) by the CPU 111 executing OS/application program. The graphics controller 114 also has an interface for outputting an analog video signal to an external CRT (Cathode Ray Tube) and an interface for outputting an analog video signal through an S video output connector to an external machine.

The high quality video engine (HVE) 115 has an input port 115A for inputting video data. The high quality video engine (HVE) 115 is a video processing controller for executing video processing to put video data input to the input port 115A into high image quality, which will be hereinafter referred to as image quality correction processing. This image quality correction processing is video processing dedicated to a moving image to put a moving image into high image quality and is executed to display a smooth high-quality moving image on the LCD 17. In the image quality correction processing, for example, color correction (gamma correction, white balance adjustment, brightness adjustment, contrast adjustment), sharpness adjustment, and edge enhancement are performed to improve the image quality of a moving image, and processing to improve the response speed of the LCD, etc., is performed.

The switch 118 functions as a selector for selectively outputting one of a video signal generated by the graphics controller 114 and a video signal generated by the high quality video engine (HVE) 115 to the LCD 17. The switch 118 switches the video signal to be sent to the LCD 17 between the video signal generated by the graphics controller 114 and the video signal generated by the high quality video engine (HVE) 115 in response to a switch control signal SW supplied from the EC/KBC 124 or the video control microcomputer 125, etc., for example.

The south bridge 119 controls devices on an LPC (Low Pin Count) bus. The south bridge 119 includes an IDE (Integrated Drive Electronics) controller for controlling the HDD 121 and the ODD 122. Further, the south bridge 119 has a function to control access to the BIOS-ROM 120 and a function to control devices on a PCI (Peripheral Component Interconnect) bus 20. The TV tuner capture unit 123 is connected to the PCI bus 20.

The TV tuner capture unit 123 is connected to the PCI bus 20 through a bus connector 30. The bus connector 30 is implemented as a Mini PCI connector, for example. The TV tuner capture unit 123 is a video data receiver for receiving external video data (TV broadcast signal, video data from an external machine, etc.,) under the control of a TV tuner capture driver. The TV tuner capture driver is a control program for controlling the TV tuner capture unit 123. The TV tuner capture unit 123 receives video data and outputs the received video data onto the PCI bus 20. In this case, the received video data is compressed and coded according to a compression coding system such as MPEG2 (MPEG: Moving Picture Coding Experts Group), for example, in the TV tuner capture unit 123 and then the compressed and coded video data is output onto the PCI bus 20. The compressed and coded video data is decoded by the TV application program and then the video data is displayed on the LCD 17.

The TV tuner capture unit 123 also has a function of transmitting the received video data directly to the high quality video engine (HVE) 115 not via the PCI bus 20. That is, a video data transmission path 21 is placed between an input port of the high quality video engine (HVE) 115 and the TV tuner capture unit 123. The video data transmission path 21 is made up of a plurality of signal lines for AV data transfer. The TV tuner capture unit 123 transmits the received video data to the high quality video engine (HVE) 115 via the video data transmission path 21. The video data flowing on the video data transmission path 21 is high-quality raw video data (uncompressed and uncoded data). The data buffer 126 is inserted into the video data transmission path 21. The raw video data is input to the high quality video engine (HVE) 115 through the data buffer 126.

The TV tuner capture unit 123 is also connected to a serial bus (I²C bus) through the bus switch 127 to execute communications with the video control microcomputer 125. The I²C bus is used as a control line to transmit various commands from the video control microcomputer 125 to the TV tuner capture unit 123. The TV tuner capture unit 123 can receive not only a command supplied from the CPU 111 via the PCI bus 20, but also a command supplied from the video control microcomputer 125 via the I²C bus.

The embedded controller/keyboard controller IC (EC/KBC) 124 is a one-chip microcomputer into which an embedded controller for power management and a keyboard controller for controlling the keyboard (KB) 13 and the touch pad 16 are integrated. The embedded controller/keyboard controller IC (EC/KBC) 124 has a function of turning on/off the power of the computer 10 in response to user's operation of the power button 14. When the TV start button 15A is operated, the embedded controller/keyboard controller IC (EC/KBC) 124 turns on the power of only the units involved in TV viewing (TV tuner capture unit 123, video control microcomputer 125, high quality video engine (HVE) 115, LCD 17, etc.,).

The video control microcomputer 125 is a microcomputer that can operate independently of the CPU 111. The video control microcomputer 125 transmits a command to the TV tuner capture unit 123 via the I²C bus, thereby controlling the operation of the TV tuner capture unit 123.

The embedded controller/keyboard controller IC (EC/KBC) 124 may be provided with the function of the video control microcomputer 125.

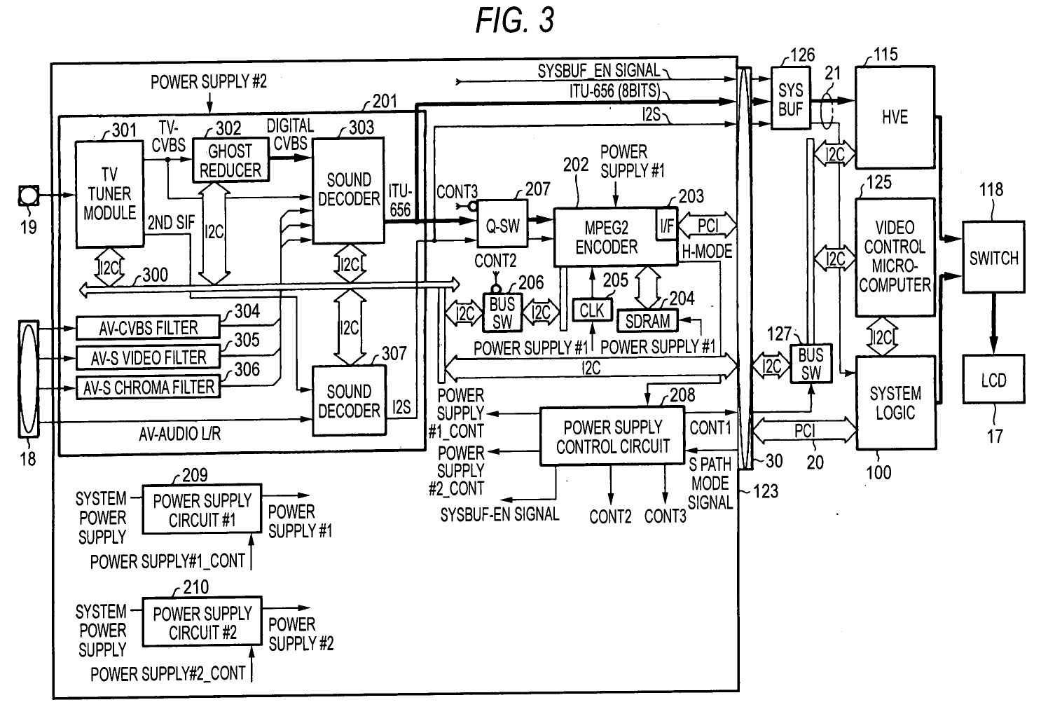

Next, the configuration of the TV tuner capture unit 123 will be discussed with reference to FIG. 3.

The TV tuner capture unit 123 is connected to a system logic 100 of the computer 10 through the bus connector 30 and the PCI bus 20. The system logic 100 functions as a host system of the TV tuner capture unit 123. The system logic 100 includes the CPU 111, the north bride 112, the main memory 113, the graphics controller 114, the south bridge 119, the BIOS-ROM 120, the hard disk drive (HDD) 121, the optical disk drive (ODD) 122, the embedded controller/keyboard controller IC (EC/KBC) 124, etc., in FIG. 2.

The TV tuner capture unit 123 includes a reception unit 201, an MPEG2 encoder 202, a bus interface unit 203, a synchronous DRAM (SDRAM) 204, a clock generator 205, a bus switch (BUS SW) 206, a Q switch (Q-SW) 207, a power supply control circuit 208, a first power supply circuit 209, and a second power supply circuit 210.

The reception unit 201 is driven by a second power supply #2 output from the second power supply circuit 210. The second power supply circuit 210 generates the second power supply #2 from system power supplied from a power supply unit in the system logic 100. The MPEG2 encoder 202, the bus interface unit 203, the synchronous DRAM (SDRAM) 204, and the clock generator 205 are driven by a first power supply #1 output from the first power supply circuit 209. The first power supply circuit 209 generates the first power supply #1 from the system power supply.

The reception unit 201 executes video data reception processing in response to a command from the CPU 111 or the video control microcomputer 125. The reception unit 201 is implemented as a global TV tuner unit. The reception unit 201 supports different types of TV broadcast systems (for example, NTSC-M/M, PAL-/I, PAL-B/G, SECAM-L/L′,PAL-D/D, etc.,). The reception unit 201 includes a TV tuner module 301, a ghost reducer 302, a video decoder 303, three low-pass filters (AV-CVBS filter, AV-SVideo filter, and AV-Schroma filter) 304, 305, and 306, and a sound decoder 307. The TV tuner module 301, the ghost reducer 302, the video decoder 303, and the sound decoder 307 are connected to a serial bus (I²C bus) 300.

The TV tuner module 301 is connected to the TV antenna connector 19 so as to receive a TV broadcast signal carrying video data and audio data. The TV tuner module 301 is designed so as to be able to tune various TV broadcast signal frequencies corresponding to the different types of TV broadcast systems described above. The TV tuner module 301 demodulates the received TV broadcast signal to generate video data in composite signal (TV-CVBS) format, for example, and audio data in 2nd SIF format, for example. The video data is sent through the ghost reducer 302 to the video decoder 303 as TV input and is also sent directly to the video decoder 303 as TV input.

The ghost reducer 302 is circuit for executing ghost reduction processing to reduce the ghost of video data from the TV tuner module 301. The ghost reduction processing is executed using a ghost removal reference signal GCR (Ghost Cancel Reference) included in vertical blanking interval (VBI) of the video data. The ghost reducer 302 includes a ghost removal filter. The ghost reducer 302 detects GCR in the video data and controls the tap coefficient of the ghost removal filter in response to distortion of the GCR. The TV broadcast system with GCR superposed on a TV broadcast signal is Japanese NTSC only. Therefore, the ghost reduction processing can function effectively only if the Japanese NTSC signal is received.

The video decoder 303 has a TV input port for inputting the video data from the ghost reducer 302 (digital CVVS) and a TV input port for directly inputting the video data from the TV tuner module 301 (TV-CVBS). The video decoder 303 also has three video input ports for inputting composite video data CVBS, S-video data (Y), and S-chroma data (C) input from the AV connector set 18 through the AV-CVBS filter 304, the AV-SVideo filter 305, and the AV-Schroma filter 306.

The video decoder 303 executes video signal processing to decode the input video data (Y/C separation processing, noise reduction processing, etc.,) to generate digital video data in ITU-656 format, for example. The digital video data in ITU-656 format is input to the MPEG2 encoder 202 through the Q switch 207. The digital video data in ITU-656 format is also sent to the data buffer (SYS BUF) 126 through the bus connector 30 as uncompressed raw video data. The bus connector 30 has a plurality of pins unassigned to connection to the PCI bus 20 and some of the unassigned pins are used as the video data transmission path 21 for sending digital video data to the data buffer (SYS BUF) 126.

The Y/C separation processing and the digital noise reduction processing are processing to put video data into high quality like the ghost reduction processing. The Y/C separation processing is processing of separating a composite signal (video data in CVBS format) into a Y (brightness) signal and a C (chroma) signal. The video decoder 303 can selectively execute the following three types of Y/C separation processing:

Three-dimensional Y/C separation processing

Two-dimensional (five-line) Y/C separation processing

One-dimensional (band-pass filter BPS) Y/C separation processing

In the embodiment, the video decoder 303 executes the Y/C separation processing optimum for the TV broadcast system of input video data and the input source (TV input, CVBS video input, or S video input). Accordingly, the input video data can be played back and recorded with high image quality. The TV broadcast system can be identified using a known art (for example, JP-A-6-335005).

The video decoder 303 can also execute the following two types of noise reduction processing:

Three-dimensional noise reduction processing

Color distortion correction processing

In the embodiment, the video decoder 303 executes the noise reduction processing optimum for the TV broadcast system of input video data and the input source (TV input, CVBS video input, or S video input). Accordingly, the input video data can be played back and recorded with high image quality.

The sound decoder 307 decodes audio data input from the TV tuner module 301 or the AV connector set 18 to generate digital audio data in I2S format, for example. The digital audio data in I2S format is input to the MPEG2 encoder 202 through the Q switch 207 and is also sent to the data buffer (SYS BUF) 126 through the bus connector 30 as uncompressed raw video data.

The MPEG2 encoder 202 is a PCI device. The MPEG2 encoder 202 compresses and codes the digital video data in the ITU-656 format and the digital audio data in the I2S format to generate a compressed and coded AV stream. This compression and coding processing is executed in the SDRAM 204. The compressed and coded AV stream is sent through the bus interface unit 203, the bus connector 30, and the PCI bus 20 to the system logic 100.

The MPEG2 encoder 202 is provided with the bus interface unit 203. The bus interface unit 203 is connected to the PCI bus 20 through the bus connector 30 for executing communications with the system logic 100 via the PCI bus 20. The bus interface unit 203 is provided with a plurality of registers that can be accessed by the CPU 111.

The power supply control circuit 208 controls the first power supply #1 and the second power supply #2 by two power supply control signals (power supply #1_CONT and power supply #2_CONT). The power supply control circuit 208 controls the bus switch (BUS SW) 127, the bus switch (BUS SW) 206, and the Q switch (Q-SW) 207 by three control signals (CONT1 to CONT3) and also controls the data buffer (SYS BUF) 126 by a buffer enable signal (SYSBUF-EN).

The bus switch (BUS SW) 206 is a switch for connecting and disconnecting the reception unit 201 and the MPEG2 encoder 202 (including the bus interface unit 203). When the bus switch (BUS SW) 206 is on, the modules in the reception unit 201 can receive a command supplied via the PCI bus 20 from the CPU 111. The operation of each module is controlled by the command. On the other hand, if the bus switch (BUS SW) 206 is off, the reception unit 201 is disconnected from the MPEG2 encoder 202 of a PCI device.

When the bus switch (BUS SW) 127 is on, the modules in the reception unit 201 are electrically connected to system I²C bus. Accordingly, the modules in the reception unit 201 can receive a command supplied via the system I²C bus from the video control microcomputer 125. The operation of each module is controlled by the command.

The TV tuner capture unit 123 can operate in the following three operation modes:

1) Normal Mode

The normal mode is a mode of outputting compressed and coded AV data onto the PCI bus 20. The data buffer (SYS BUF) 126 is turned off. Accordingly, raw video data and raw audio data are not sent to the system. The TV application program decodes the compressed and coded AV data. The decoded video data is displayed on the LCD 17 by the graphics controller 114. The TV application program can also record the compressed and coded AV data in the HDD 121.

2) High Image Quality display Mode

The high image quality display mode is a mode of transmitting raw video data and raw audio data to the system via the video data transmission path 21. In the high image quality display mode, the data buffer (SYS BUF) 126 is turned on. The raw video data is sent to the high quality video engine 115 via the video data transmission path 21. The high quality video engine 115 corrects the image quality of the raw video data and then displays a dynamic image corresponding to the raw video data on the LCD 17. The AV data compressed and coded by the MPEG2 encoder 202 is also output onto the PCI bus 20. Thus, while a TV broadcast program, etc., is displayed on the LCD 17 with high image quality, the compressed and coded data of the TV broadcast program can be recorded in the HDD 121.

3) TV Function High-Speed Start Mode

The TV function high-speed start mode is a mode of playing back AV data received by the TV tuner capture unit 123 without starting the operating system. In the TV function high-speed start mode, the system logic 100 is powered off. The reception unit 201 is controlled by the video control microcomputer 125. The MPEG2 encoder 202 (including the bus interface unit 203) connected to the PCI bus 20 is also powered off. The AV data is transmitted as with the high image quality display mode. That is, raw video data and raw audio data are transmitted to the system via the video data transmission path 21. The data buffer (SYS BUF) 126 is turned on. The raw video data is sent to the high quality video engine 115 via the video data transmission path 21. The high quality video engine 115 corrects the image quality of the raw video data and then displays a dynamic image corresponding to the raw video data on the LCD 17. The bus interface unit 203 may be implemented as a device independent of the MPEG2 encoder 202. In this case, only the bus interface unit 203 functions as a PCI device.

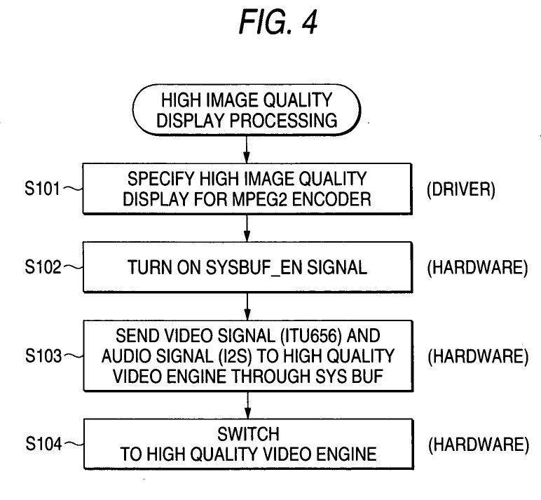

Next, a procedure of high image quality display processing will be discussed with reference to a flowchart of FIG. 4.

The TV tuner capture driver sets a command specifying the high image quality display mode in the register of the bus interface unit 203 via the PCI bus 20 (step S101). The bus interface unit 203 transmits a high image quality display mode signal (H-Mode) to the power supply control circuit 208. The power supply control circuit 208 activates the buffer enable signal (SYSBUF-EN) in response to the high image quality display mode signal (H-Mode) (step S102). Accordingly, the data buffer (SYS BUF) 126 is turned on.

The reception unit 201 receives AV data from the source specified by the TV tuner capture driver. Raw video data and raw audio data are transmitted to the system through the data buffer (SYSBUF) 126 (step S103). The high quality video engine (HVE) 115 is selected according to the switch control signal SW and the video signal generated by the high quality video engine (HVE) 115 is sent to the LCD 17 (step S104).

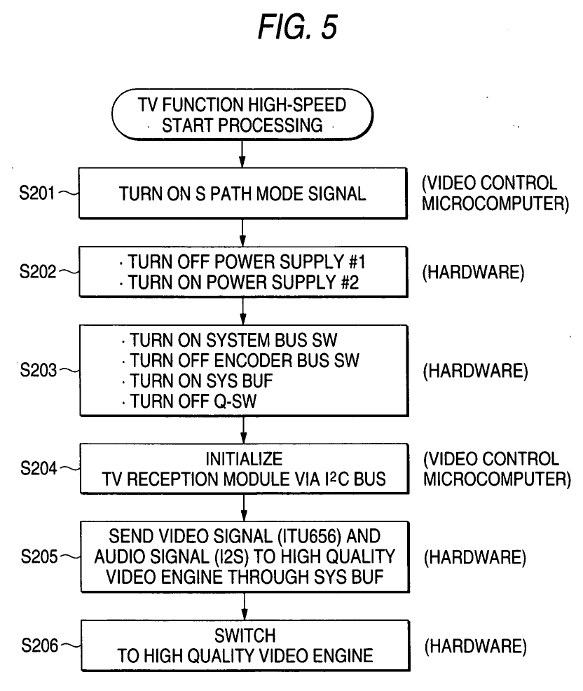

Next, a procedure of TV function high-speed start processing will be discussed with reference to a flowchart of FIG. 5.

First, the video control microcomputer 125 transmits a signal indicating the TV function high-speed start mode (S Path Mode Signal) to the TV tuner capture unit 123 through the bus connector 30 (step S201). The power supply control circuit 208 turns off the first power supply #1 and turns on the second power supply #2 in response to the S Path Mode Signal (step S202). Next, the power supply control circuit 208 turns on the bus switch (BUS SW) 127, turns off the bus switch (BUS SW) 206, turns on the data buffer (SYS BUF) 126, and turns off the Q switch (Q-SW) 207 (step S203). The video control microcomputer 125 initializes the modules in the reception unit 201 via the I²C bus (step S204). The reception unit 201 receives AV data from the source specified by the video control microcomputer 125. Raw video data and raw audio data are transmitted to the system through the data buffer (SYS BUF) 126 (step S205). The high quality video engine (HVE) 115 is selected according to the switch control signal SW and the video signal generated by the high quality video engine (HVE) 115 is sent to the LCD 17 (step S206).

As described above, the TV tuner capture unit 123 of the embodiment not only can output compressed and coded video data onto the PCI bus 20, but also can transmit uncompressed video data directly to the high quality video engine (HVE) 115. Thus, a moving image of a TV broadcast program, etc., can be displayed on the LCD 17 with sufficiently high image quality without incurring an increase in the traffic of the PCI bus 20. Since the reception unit 201 can be controlled via the I²C bus not via the PCI bus 20, a moving image of a TV broadcast program, etc., can be displayed on the LCD 17 with sufficiently high image quality without booting up the operating system.

The normal mode of the TV tuner capture unit 123 can also be used with a usual computer not having the function of the high quality video engine (HVE) 115 or the video control microcomputer 125. The data buffer (SYS BUF) 126 and the bus switch (BUS SW) 127 may be installed in the TV tuner capture unit 123. However, the data buffer (SYS BUF) 126 and the bus switch (BUS SW) 127 are used in a system installing the high quality video engine (HVE) 115 or the video control microcomputer 125. Thus, the configuration wherein the data buffer (SYS BUF) 126 and the bus switch (BUS SW) 127 are installed in the system is effective for decreasing the number of parts of the TV tuner capture unit 123 and the cost.

The system configuration of the embodiment can be applied not only to a personal computer, but also to an electronic apparatus such as an AV machine.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. An electronic apparatus capable of displaying video data on a display, comprising:
a bus;
a processor being electrically connected to the bus;
a display controller generating a first video signal that can be displayed on the display from display data written into video memory by the processor;
a video processing controller inputting video data to be displayed on the display and performing video processing of the input video data to generate a second video signal that can be displayed on the display;
a selector switching a video signal to be sent to the display between the first video signal generated by the display controller and the second video signal generated by the video processing controller;
a receiver being electrically connected to the bus, and the receiver receiving external video data in response to a command supplied via the bus from the processor; and
a video data transmission path being placed between the receiver and the video processing controller, and the video data transmission path transmitting the video data received by the receiver from the receiver to the video processing controller not via the bus.

2. The electronic apparatus according to claim 1, wherein the receiver includes:
a tuner section receiving a broadcast signal carrying the video data;
a video signal processing section executing video signal processing for decoding the video data included in the broadcast signal received by the tuner section; and
a coding section compressing and coding the video data decoded by the video signal processing section, and the coding section outputting the compressed and coded video data onto the bus, and wherein the video data transmission path is connected to output of the video signal processing section for transmitting the video data decoded by the video signal processing section to the video processing controller.

3. The electronic apparatus according to claim 1, wherein the receiver is connected to the bus through a bus connector including a plurality of signal pins, and
wherein the video data transmission path is derived from the bus connector to the video processing controller through signal pins of the bus connector unassigned to connection to the bus.

4. The electronic apparatus according to claim 3, further comprising:
a data buffer inserted into the video data transmission path derived from the bus connector to the video processing controller.

5. The electronic apparatus according to claim 1 further comprising:
a controller operating independently of the processor and transmitting a command to the receiver; and
a control line transmitting the command from the controller to the receiver, wherein the receiver is connected to the control line to receive the command supplied from the controller.

6. An electronic apparatus capable of displaying video data on a display, comprising:
a bus;
a processor being electrically connected to the bus;
a display controller generating a first video signal that can be displayed on the display from display data written into video memory by the processor;
a video processing controller inputting video data to be displayed on the display and performing video processing of the input video data to generate a second video signal that can be displayed on the display;
a receiver having an interface unit being electrically connected to the bus and a reception unit receiving external video data;
a video data transmission path being placed between the reception unit and the video processing controller, and the video data transmission path transmitting the video data received by the reception unit from the receiver to the video processing controller not via the bus;
a controller operating independently of the processor, the controller executing processing of issuing a command for controlling the receiver and processing of switching the video signal to be sent to the display from the first video signal generated by the display controller to the second video signal generated by the video processing controller; and
a control line transmitting the command from the controller to the reception unit not via the bus.

7. The electronic apparatus according to claim 6, further comprising:
a device being installed in the receiver, and the device turning off power of the interface unit if the video data is received in response to the command from the controller.

8. A video data receiver being placed in an electronic apparatus including a bus; a processor being electrically connected to the bus; a display controller for generating a first video signal that can be displayed on the display from display data written into video memory by the processor; a video processing controller inputting video data to be displayed on the display and performing video processing of the input video data to generate a second video signal that can be displayed on the display; a selector switching the video signal to be sent to the display between the first video signal generated by the display controller and the second video signal generated by the video processing controller; the video data receiver comprising:
a bus interface unit being electrically connected to the bus;
a reception unit receiving external video data to be displayed on the display in response to a command supplied from the processor through the bus interface unit; and
a video data transmission path transmitting the video data received by the reception unit to the video processing controller not via the bus.

9. The video data receiver as according to claim 8, wherein the reception unit includes:
a tuner section for receiving a broadcast signal carrying the video data; and
a video signal processing section executing video signal processing for decoding the video data included in the broadcast signal received by the tuner section, and
wherein the video data transmission path is connected to output of the video signal processing section for transmitting the video data decoded by the video signal processing section to the video processing controller.

10. The video data receiver according to claim 8, further comprising:
a coding section compressing and coding the video data received by the reception unit, and the coding section outputting the compressed and coded video data onto the bus through the bus interface unit.
